(19) United States
(12) Patent Application Publication
(10) Pub. No.: US 2025/0180420 A1
(43) Pub. Date: Jun. 5, 2025

(54) TOOL AND METHOD FOR DETERMINING THE PEENING INTENSITY OF A SHOT PEENING MACHINE

(71) Applicant: The Boeing Company, Arlington, VA (US)

(72) Inventors: Rebekah Gaddi-Nguyen, Oregon City, OR (US); Jonas Mendoza, Fairview, OR (US); Ryan P. Rouse, Vancouver, WA (US); Jordan Harmon, Gresham, OR (US); William T. Andrianoff, Portland, OR (US); Keith P. White, Sandy, OR (US)

(21) Appl. No.: 18/527,267

(22) Filed: Dec. 2, 2023

(51) Int. Cl. G01L 5/00; B24C 1/10

(52) U.S. Cl. CPC G01L 5/0052; B24C 1/10

(57) ABSTRACT

A verification tool for a shot peening machine has a sensor support frame configured to be mounted within the shot peening machine. The sensor support frame has at least three faces facing outwardly in different directions, and each face is configured to receive an electronic impact sensor configured to measure the peening intensity of peening media discharged from one or more nozzles of the shot peening machine.

### FIELD

The present disclosure relates generally to shot peening and, more particularly, to a tool and method for determining the peening intensity of peening media discharged from the nozzle(s) of a shot peening machine.

### BACKGROUND

Shot peening is a cold-working process for improving the mechanical properties of a metallic workpiece. The process involves subjecting the surface of the workpiece to a high-velocity stream of peening media. The peening media is comprised of small pellets (e.g., shot) formed of a relatively hard material such as steel, glass, ceramic, or other material. The shot creates small dents or dimples in the surface of the workpiece. The peening process is typically applied to workpiece surfaces until there is uniform dimpling of the workpiece surface when viewed with the unaided eye. The dimples induce compressive residual surface stresses that improve the resistance of the workpiece to crack formation and fatigue failure.

Prior to peening a workpiece, it is necessary to determine the peening intensity of the stream on the workpiece, as peening intensity characterizes the magnitude of the compressive stress that will be introduced into the workpiece surfaces. The conventional method for determining peening intensity involves the use of flat, thin, steel test strips referred to as Almen strips, and requires measuring the pre-bow of each Almen strip using a special dial gauge (i.e., an Almen gauge), then mounting the Almen strip on a conventional strip holder (e.g., a J442 strip holder, also referred to as an Almen strip holder or Almen block) which is installed on a fixture (e.g., a dummy workpiece) that is placed in the shot peening machine. For fixtures that have complex shapes, Almen strips are typically mounted at different locations on the fixture to assess the peening intensity at each location. After the fixture is placed in the shot peening machine, the shot peening machine is activated causing the Almen strips to be peened on one side. The fixture is then removed from the shot peening machine and the Almen strips are removed from the fixture.

As a result of peening on only one side, each Almen strip assumes an arc shape. The peened Almen strips are again placed on the dial gauge and the arc height of each Almen strip is measured. The arc height of each Almen strip is correlated to the peening intensity at the location of the Almen strip on the fixture. Peening intensity is an indirect measure of the impact force of the peening media on a workpiece, and can be expressed in terms of the arc height and the standardized thickness of the Almen strip. For example, an arc height of 0.006 inch for an Almen strip of thickness 0.051 inch can be correlated to a peening intensity of 0.006 A.

The peening parameters of a shot peening machine can be adjusted multiple times until the desired peening intensity is achieved. For example, different combinations of air pressure, nozzle stand-off distance, angle of impingement, and volumetric flow rate of the peening media can be tested until achieving the desired surface properties without over-peening or under-peening the workpiece. Unfortunately, each time the peening parameters are adjusted, the above-noted steps must be repeated for each location where Almen strips are mounted on the fixture. As may be appreciated, the repetitive mounting, peening, removing, and measuring of multiple Almen strips is a time-consuming process requiring a large number (e.g., hundreds) of Almen strips. Furthermore, once an Almen strip has been peened, it cannot be reused and must be discarded as waste. In addition, the above-noted method is subject to error due to incorrect mounting of the Almen strips or incorrect measurement of the curvature of the Almen strips after peening.

As can be seen, there exists a need in the art for a system and method for determining the peening intensity of a shot peening machine that avoids the above-noted drawbacks associated with the conventional method.

### SUMMARY

The above-noted needs associated with determining the peening intensity of a shot peening machine are addressed by the present disclosure, which provides a verification tool having a sensor support frame configured to be mounted within the shot peening machine. The sensor support frame has at least three faces facing outwardly in different directions, and each face is configured to receive an electronic impact sensor configured to measure the peening intensity of peening media discharged from one or more nozzles of the shot peening machine.

Also disclosed is a verification tool having a sensor support frame configured to be mounted within the shot peening machine. The sensor support frame has at least three faces facing outwardly in different directions. The verification tool also has an electronic impact sensor mountable to each of the faces. Each impact sensor is configured to measure the peening intensity of peening media discharged from one or more nozzles of the shot peening machine.

In addition, disclosed is a method of determining the peening intensity of a shot peening machine. The method includes mounting an electronic impact sensor on each of at least three faces of a sensor support frame of a verification tool, placing the verification tool in a shot peening machine, and measuring, using the impact sensors, the peening intensity of peening media discharged from one or more nozzles of the shot peening machine.

The features, functions, and advantages that have been discussed can be achieved independently in various versions of the disclosure or may be combined in yet other versions, further details of which can be seen with reference to the following description and drawings.

### BRIEF DESCRIPTION OF THE DRAWINGS

The disclosure can be better understood with reference to the following detailed description taken in conjunction with the accompanying drawings, which illustrate preferred and exemplary versions, but which are not necessarily drawn to scale. The drawings are examples and not meant as limitations on the description or the claims.

FIG. 1 shows an example of a shot peening machine;

FIG. 2 shows an example of a workpiece mounted in a cabinet of the shot peening machine in preparation for a peening operation;

FIG. 3 is a magnified view of a portion of the workpiece of FIG. 2 showing peening media discharged in a stream from a nozzle of the shot peening machine;

FIG. 4 is a magnified view of a portion of the workpiece of FIG. 3 illustrating peening particles (i.e., shot) impacting the workpiece surface;

FIG. 5 shows an example of the presently-disclosed verification tool mounted in the shot peening machine of FIGS. 1-2 for verifying the peening intensity of the shot peening machine;

FIG. 6 is a top perspective view of the verification tool of FIG. 5 comprising a sensor support frame having multiple faces facing outwardly in different directions, and further illustrating an electronic impact sensor mounted on each face for measuring the peening intensity of peening media discharged from the nozzles of a shot peening machine;

FIG. 7 is a bottom perspective view of the verification tool of FIG. 6 and illustrating a grounding mechanism in the form of a grounding pin protruding from the base portion of the verification tool;

FIG. 8 is a top view of the verification tool of FIGS. 6-7;

FIG. 9 is a view of the verification tool showing a sensor-plate assembly separated away from the verification tool and comprising an impact sensor coupled to a sensor mounting plate;

FIG. 10 is a partially exploded view of the verification tool showing the base portion separated away from the sensor support frame;

FIG. 11 is an exploded view of the sensor support frame comprising a plurality of structure segments that interlock with each other to form a primary structure, and further illustrating a protective outer layer for covering the exterior surfaces of the primary structure of each structure segment;

FIG. 12 is a sectional view of the verification tool illustrating a plurality of grounding wires extending respectively between the grounding pins and the impact sensors;

FIG. 13 shows an example of the plurality of grounding wires individually coupled to the pin housing of the grounding pin via a plurality of electrical connectors;

FIG. 14 shows an example of the plurality of grounding wires feeding into two multi-pin connectors mounted on top of the pin housing;

FIG. 15 is a perspective view of an example of a sensor-plate assembly comprising an impact sensor coupled to a sensor mounting plate;

FIG. 16 is an exploded top perspective view of the sensor-plate assembly of FIG. 15 illustrating a hole pattern that is common to a standardized strip holder (i.e., a J442 strip holder) conventionally used for holding an Almen strip which is shown in FIGS. 20-21;

FIG. 17 is an exploded bottom perspective view of the sensor-plate assembly of FIG. 16 and illustrating screws extending upwardly from a bottom side of the sensor mounting plate and into threaded holes in the impact sensor;

FIG. 18 is a side view of an impact sensor subjected to peening media discharged from a nozzle of the shot peening machine;

FIG. 19 shows an example of a display screen of a computing device displaying a chart listing each impact sensor on the verification tool and the peening intensity corresponding to each impact sensor;

FIG. 20 shows an example of a strip-plate assembly comprising a conventional Almen strip mounted on a strip holder coupled to a sensor mounting plate, and which is installed in one of the pockets at a faces of the verification tool;

FIG. 21 is an exploded view of the strip-plate assembly of FIG. 20 showing four screws for securing the Almen strip to the strip holder using the same hole pattern that is used for attaching the impact sensor to the sensor mounting plate in FIG. 17;

FIG. 22 shows an example of a dial gauge (i.e., an Almen gauge) for measuring the arc height of an Almen strip for calibrating the impact sensors on the remaining faces of the verification tool of FIG. 20;

FIG. 23 shows the Almen strip of FIG. 22 having an arc shape as a result of peening on one side while supported on the verification;

FIG. 24 is a flowchart of operations included in a method of determining the peening intensity of a shot peening machine.

The figures shown in this disclosure represent various aspects of the versions presented, and only differences will be discussed in detail.

### DETAILED DESCRIPTION

Disclosed versions will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one version” or “a version.” Instances of the phrases “one version” or “a version” do not necessarily refer to the same version. Similarly, this specification includes references to “one example” or “an example.” Instances of the phrases “one example” or “an example” do not necessarily refer to the same example. Particular features, structures, or characteristics may be combined in any suitable manner consistent with this disclosure.

As used herein, “comprising” is an open-ended term, and as used in the claims, this term does not foreclose additional structures or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, an element or step recited in the singular and preceded by the word “a” or “an” should be understood as not necessarily excluding the plural of the elements or steps. As used herein, the term “and/or” includes any and all combinations of one or more of the associated listed items. As also used herein, the term “combinations thereof” includes combinations having at least one of the associated listed items, wherein the combination can further include additional, like non-listed items.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

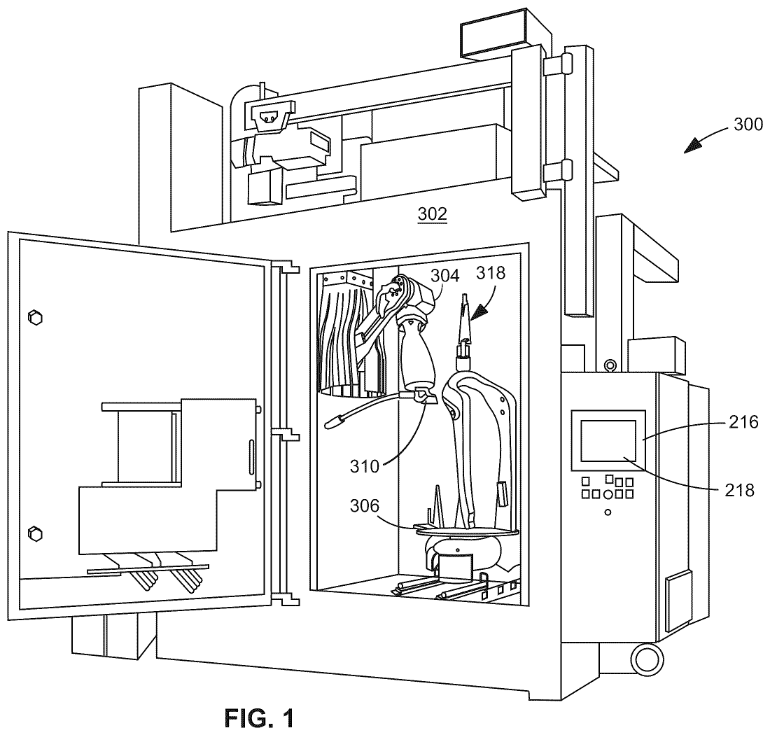

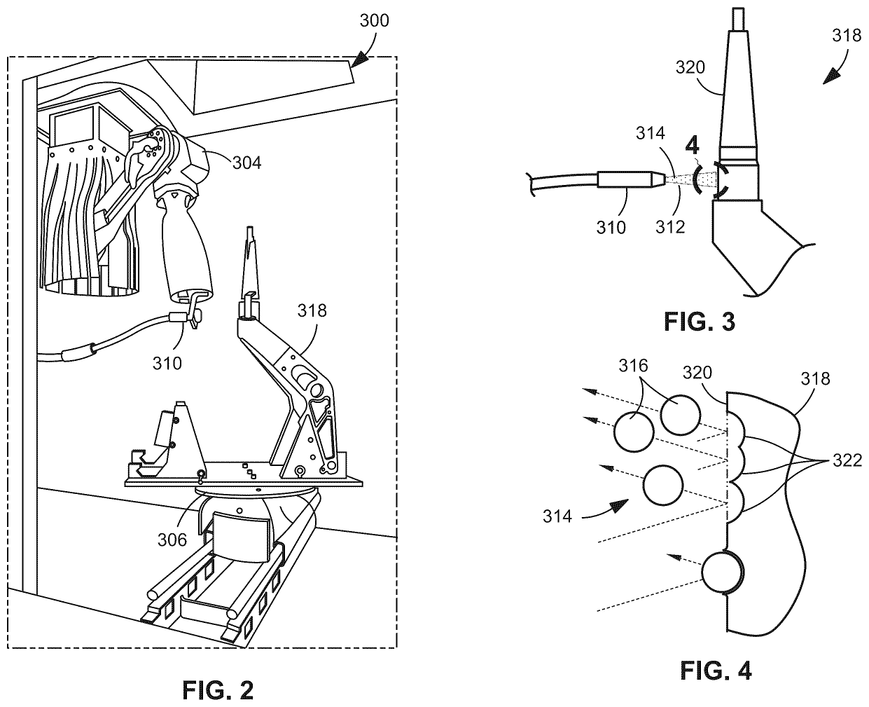

Referring now to the drawings which illustrate various examples of the disclosure, shown in FIGS. 1-2 is an example of a shot peening machine 300 for peening a metallic workpiece 318. As described above, peening involves subjecting the workpiece surfaces 320 to a high-velocity stream 312 of peening media 314 as a means to improve the mechanical properties of the workpiece 318. In the example shown, the shot peening machine 300 is a robotic shot peening machine having a cabinet 302 containing a robotic arm 304 for moving a nozzle 310 into any one of a variety of orientations and/or positions. The shot peening machine 300 also includes a table 306 for supporting the workpiece 318. In the example shown, the table 306 is an indexing turntable configured to rotate the workpiece 318 during peening operations. In other examples not shown, the table 306 of a shot peening machine 300 can be stationary or non-movable.

FIG. 3 shows peening media 314 discharged in a stream 312 from a nozzle 310 and impacting the workpiece surfaces 320 of the workpiece 318 of FIGS. 1-2. FIG. 4 shows peening media 314 impacting the workpiece surface 320 and forming a plurality of small dimples 322 which plastically deform a thin layer of the workpiece 318, thereby increasing the fatigue strength of the workpiece 318 and its resistance to stress corrosion cracking. The peening media 314 typically comprises small media particles 316 (e.g., spherical shot) formed of metallic, glass, ceramic, or other relatively hard material.

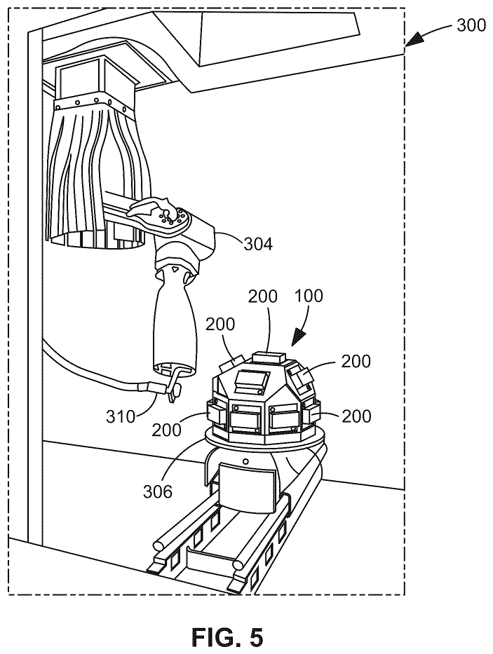

Referring to FIGS. 5-18, shown in FIG. 5 is an example of the presently-disclosed verification tool 100 mounted in the shot peening machine 300 of FIGS. 1-2 for verifying its peening intensity. When determine peening intensity, the verification tool 100 is subjected to the same peening conditions as the workpiece 318. In this regard, the verification tool 100 provides a means for calibrating the peening intensity of the shot peening machine 300.

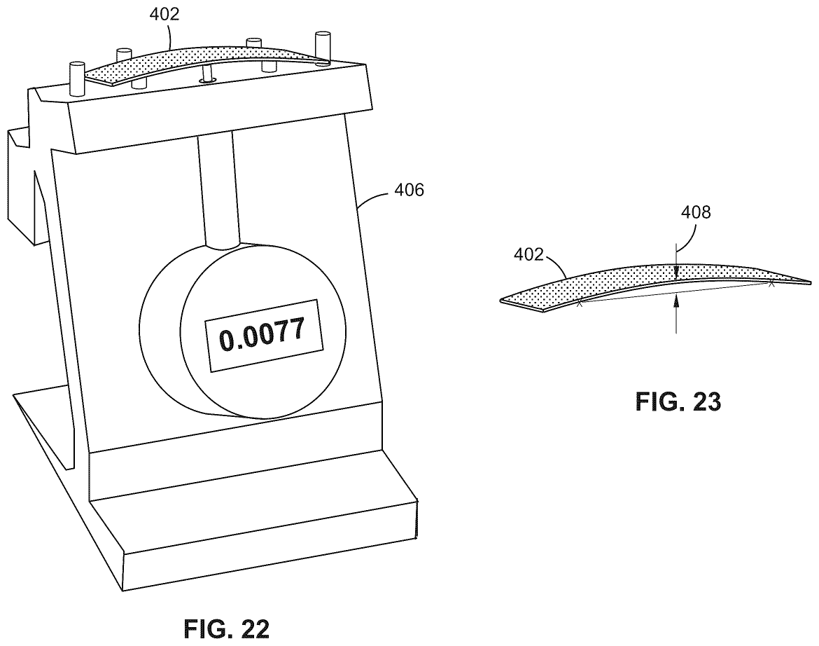

Although shown mounted in the robotic shot peening machine 300 of FIGS. 1-2, the verification tool 100 may be mounted in any type of shot peening machine 300 capable of being calibrated using Almen strips 402 (FIG. 23). For example, the verification tool 100 can be mounted in a CNC shot peening machine (not shown) configured to peen large structural components such as large airframe structures including wing ribs, skins, stringers, and other structures. In another example, the verification tool 100 can be mounted in smaller peening machines, such as a gear peening machine (not shown) for peening the gears of motor vehicles. The verification tool 100 can be mounted in any type of shot peening machine 300 for peening any one of a variety of different types of components including axles, landing gear, control surface actuators, engine components, and other types of components. The nozzles 310 of a shot peening machine 300 can be movable, either manually (i.e., handheld) or autonomously as in the robotic shot peening machine 300 of FIGS. 1-2. Alternatively, the nozzles 310 of a shot peening machine 300 can be fixed in position.

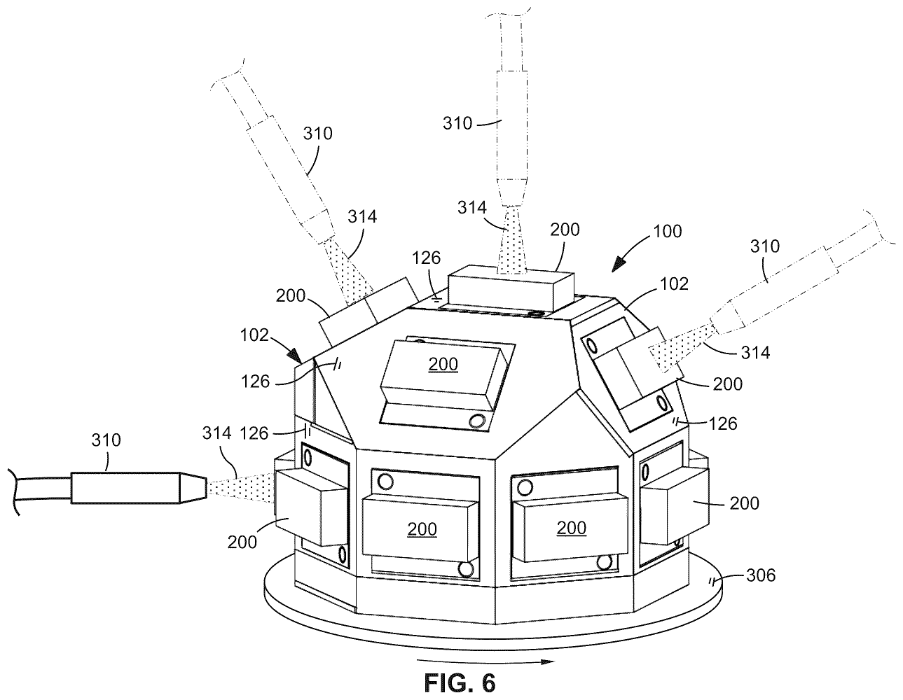

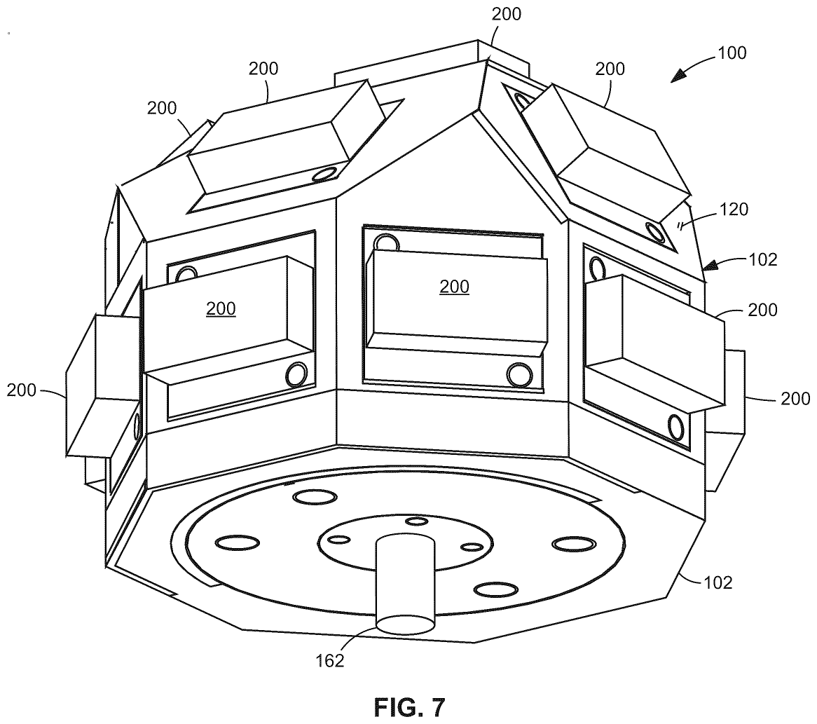

Referring to FIG. 6, shown is an example of the verification tool 100 which has a sensor support frame 102 having at least three faces 126 facing outwardly and oriented in different directions. The verification tool 100 further includes multiple electronic impact sensors 200 respectively mounted to the multiple faces 126. Each impact sensor 200 is configured to measure the energy of peening media 314 discharged from the nozzles 310 of a shot peening machine 300 and impacting the impact sensor 200.

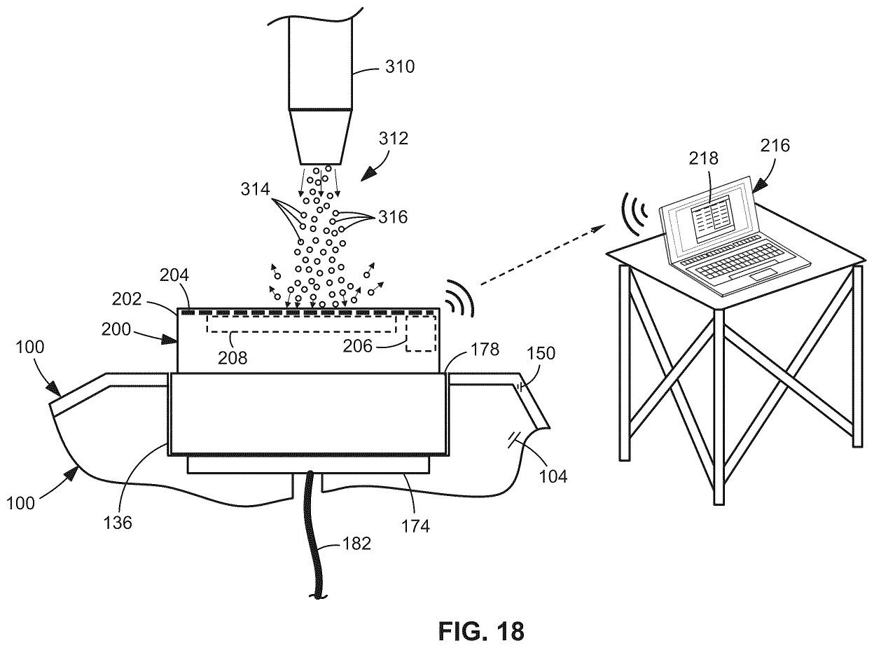

As shown in FIG. 18 and described in greater detail below, each impact sensor 200 has a load cell or transducer 204 configured to record the impact force of each particle in a stream 312 of peening media 314 impacting the impact sensor 200. The impact sensor 200 also has a processor (not shown) that uses an algorithm to calculate the energy in the stream 312 of peening media 314. The impact sensor 200 further includes a transmission unit 206 for wirelessly transmitting a digital signal representative of the energy to a computing device 216. The computing device 216 determines the peening intensity of the peening media 314 based on the energy measured by the transducer 204. As described above, peening intensity can be expressed as Almen intensity, the value of which can be displayed on a display screen 218 associated with the computing device 216. In an alternative example of the verification tool 100, each impact sensor 200 can be provided with the capability to determine the peening intensity of the stream 312 prior to transmitting the value of the peening intensity to a computing device 216.

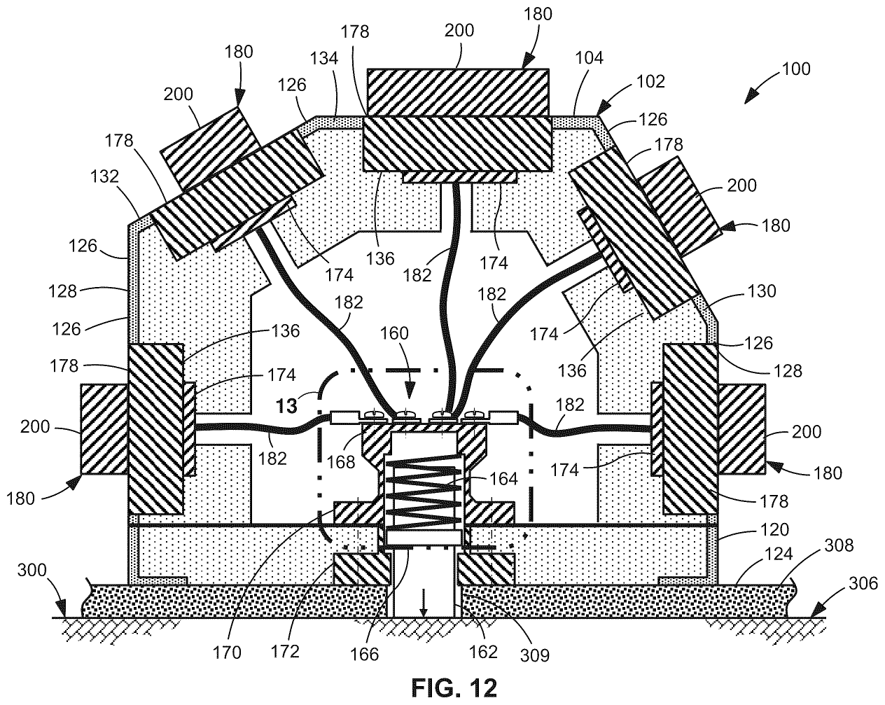

Referring to FIGS. 5-12, the sensor support frame 102 has at least three faces 126 facing outwardly in different directions as mentioned above. The three faces 126 represent a common range of nozzle 310 orientations in shot peening machines 300. As shown in FIG. 12, the sensor support frame 102 has faces 126 respectively oriented at 30, 45, and 90 degrees. The orientation of each face 126 is measured relative to a base plane 124 when the face 126 is viewed respectively from a side view perspective along a direction parallel to the base plane 124 and normal to the plane of the face 126. The three faces 126 of a verification tool 100 include a 30-degree face 132, a 45-degree face 130, and a 90-degree face 128. The base plane 124 is defined by the bottom side of the base portion 120 of the sensor support frame 102.

In the example of FIG. 5-12, the verification tool 100 has 13 faces 126, including eight 90-degree faces 128, three 45-degree faces 130, one 30-degree face 132, and one 0-degree face 134 which is located on top of the verification tool 100 and which is parallel to the base plane 124. The tolerance for each of the face orientations is within 10 degrees of the above-stated values. The faces 126 are each generally planar and they intersect adjacent faces 126, forming the shape of a convex polyhedron.

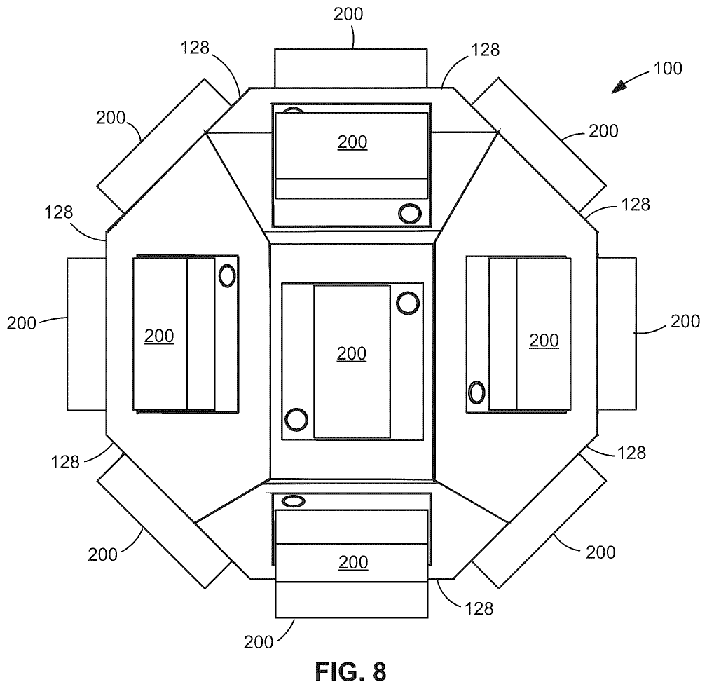

As shown in FIG. 8, the eight 90-degree faces 128 collectively define an octagonal cross-sectional shape when the verification tool 100 is viewed from a top-down perspective. However, the verification tool 100 can have any number of faces 126, and is not limited to 13 faces 126. Furthermore, the faces 126 of a verification tool 100 can be oriented at any one of a variety of angles, and are not limited to being oriented at 0, 30, 45, and/or 90 degrees. In addition, the verification tool 100 can be configured such that the faces 126 form any one of a variety of convex polyhedron shapes when viewed from a top down perspective, and is not limited to the octagonal cross-sectional shape of FIG. 8. For example, the faces 126 can be arranged such that the cross-sectional shape of the verification tool 100 when viewed from a top down perspective is triangular, quadrilateral, pentagonal, hexagonal, heptagonal, or other shapes.

Referring to FIGS. 7-12, the sensor support frame 102 has a primary structure 104 containing the faces 126. The primary structure 104 is formed of a relatively lightweight thermoplastic polymer material such as acrylonitrile butadiene styrene (ABS), polyethylene, polypropylene, polyvinyl chloride, and polystyrene, or any other preferably lightweight thermoplastic polymer that provides structural rigidity to the verification tool 100 over multiple peening operations during its lifetime.

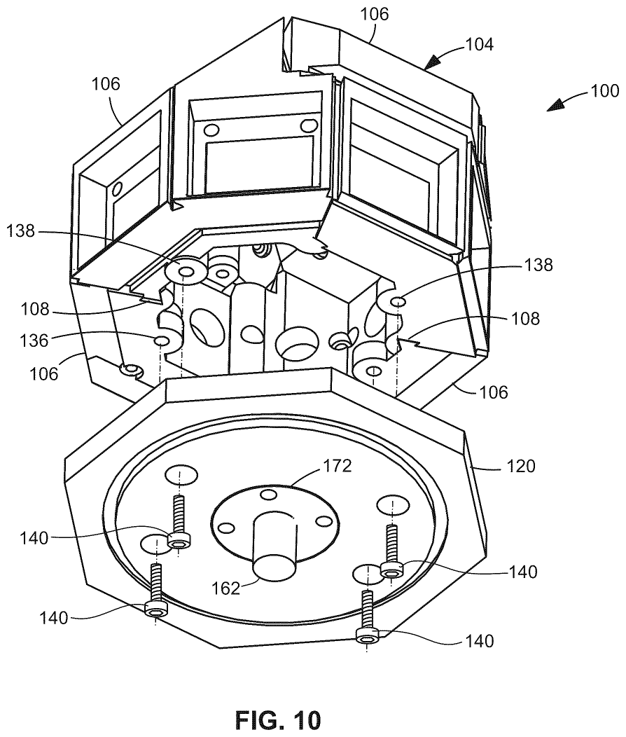

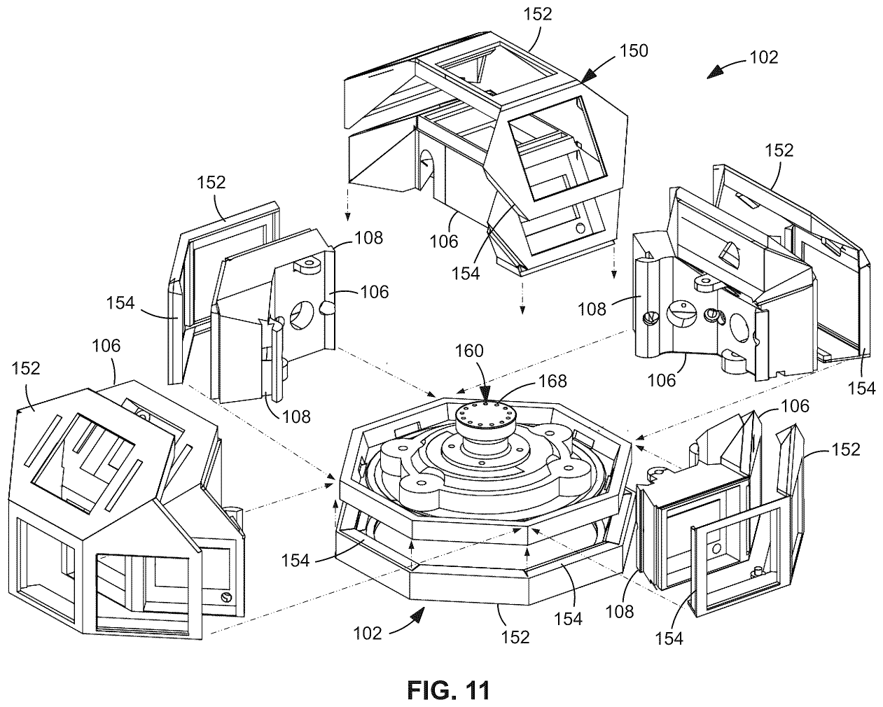

In the example of FIGS. 10-11, the primary structure 104 is made up of a plurality of structure segments 106 that interlock with each other via dovetail joints 108 (FIG. 11). Mechanical fasteners such as screws 140 (e.g., FIG. 10) are extended up through holes in the base portion 120 and into threaded bosses or inserts 138 molded into the structure segments 106 to lock together the components of the primary structure 104. Although the figures show the primary structure 104 comprised of the base portion 120 and multiple structure segments 106, in other examples not shown, the primary structure 104 can be formed as a one-piece component to which the base portion 120 can be attached using screws 140 similar to the arrangement of FIG. 10.

In the example of FIGS. 11-12, the sensor support frame 102 has a protective outer layer 150 which functions as a shot-peen-resistant outer shell that covers the exterior surfaces of the primary structure 104. The protective outer layer 150 is formed of a thermoplastic elastomer material configured to prevent the peening media 314 from impacting the primary structure 104. Examples of thermoplastic elastomer materials include thermoplastic vulcanizates, styrene-block copolymers, thermoplastic polyurethane (TPU), and any other thermoplastic elastomer material capable of absorbing the energy of the peening media 314 and protecting the underlying primary structure 104 from impacts that would otherwise degrade its structural integrity over time. The protective outer layer 150 can have a thickness of at least 0.100 inch, although smaller thicknesses are possible depending on the material composition of the protective outer layer 150 and/or the parameters (e.g., velocity, hardness, size, etc.) of the peening media 314.

In FIGS. 11-12, the protective outer layer 150 is comprised of multiple protective outer layer segments 152, each of which is shaped complementary to the exterior surfaces of the structure segment 106 that it is covering. Each protective outer layer segment 152 can be secured to its structure segment 106 using any one of a variety of different techniques. For example, in FIGS. 11-12, each protective outer layer segment 152 is secured to its structure segment 106 via tabs 154 that are folded over the edges of the structure segment 106 and sandwiched between adjacent structure segments 106 when the primary structure 104 is in its assembled state. The sensor support frame 102 can include edge tape (not shown) for sealing abutting edges of the protective outer layer 150 against the intrusion of high-speed media particles 316 that could otherwise damage the primary structure 104 and/or the components inside the verification tool 100.

In the example of FIGS. 7-14, the verification tool 100 has a grounding mechanism 160 configured to electrically ground the impact sensors 200 to the shot peening machine 300. The grounding mechanism 160 is configured to reduce the negative effects of electrostatic charges that can generate within a shot peening machine 300 during peening operations. In this manner, the grounding mechanism 160 reduces the risk of grounding failures that could compromise the accuracy of the impact sensors 200 in measuring the energy of the peening media 314.

In FIGS. 7-14, the grounding mechanism 160 includes a grounding pin 162 mounted to the base portion 120 of the sensor support frame 102. The grounding pin 162 is contained within a pin housing 168 which, in the example shown, is comprised of an inner portion 170 (FIG. 12) and an outer portion 172 (FIG. 12). The base portion 120 of the sensor support frame 102 is sandwiched between the inner portion 170 and the outer portion 172, which are coupled together via screws (not shown). The lower portion of the grounding pin 162 protrudes out of the base portion 120 as shown in FIGS. 7 and 10.

In FIG. 12, the table 306 of the shot peening machine 300 is typically formed of an electrically conductive material (e.g., steel) and may be covered with an elastomeric mat 308 such as a rubber mat for protecting the metallic table 306 against damage from the peening media 314 when the shot peening machine 300 in in operation. The grounding pin 162 is biased downwardly through an opening 309 in the elastomeric mat 308. In the example shown, the biasing mechanism is a compression spring 164 captured between a spring flange 166 on the grounding pin 162 and an upper portion of the pin housing 168. The compression spring 164 is configured to urge the grounding pin 162 downwardly into constant contact with the table 306 when the verification tool 100 is placed in a shot peening machine 300.

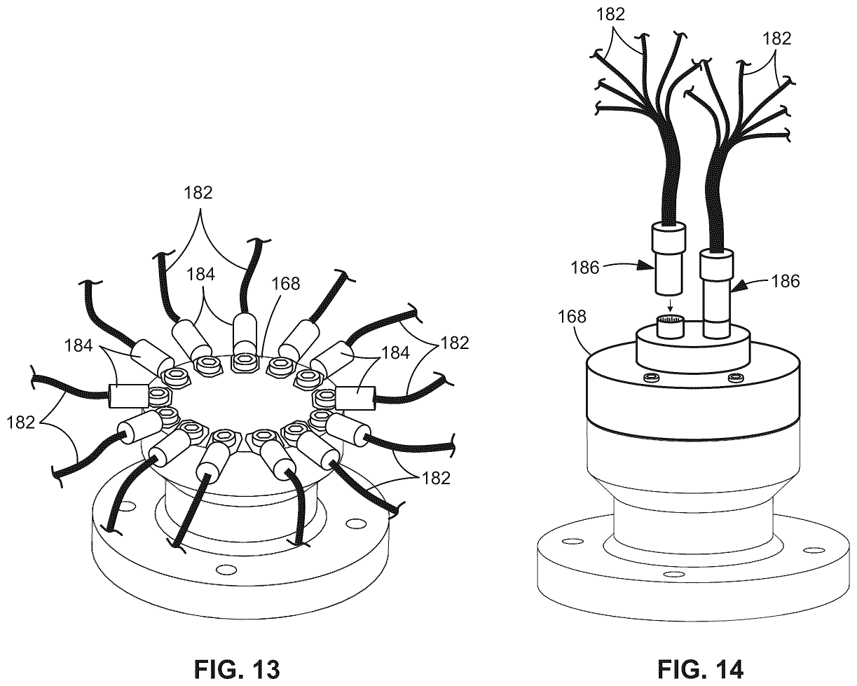

Referring to FIGS. 12-14, the grounding mechanism 160 also includes a plurality of grounding wires 182 extending respectively from the faces 126 to the grounding pin 162 for electrically grounding the impact sensors 200 to the table 306. In the example of FIG. 13, each grounding wire 182 is coupled to the pin housing 168 via electrical connectors 184. In the example of FIG. 14, multiple grounding wires 182 feed into two multi-pin connectors 186 which are mounted on the pin housing 168. Regardless of how the grounding wires 182 connect to the grounding pin 162, each grounding wire 182 is electrically coupled to an impact sensor 200 mounted on a face 126. For example, as shown in FIG. 12, each grounding wire 182 is attached to a grounding plate 174 located at a face 126 of the primary structure 104 of the sensor support frame 102. As shown in FIG. 12 and described below, each grounding plate 174 is in contact with a sensor mounting plate 178 when a sensor-plate assembly 180 in attached to a face 126.

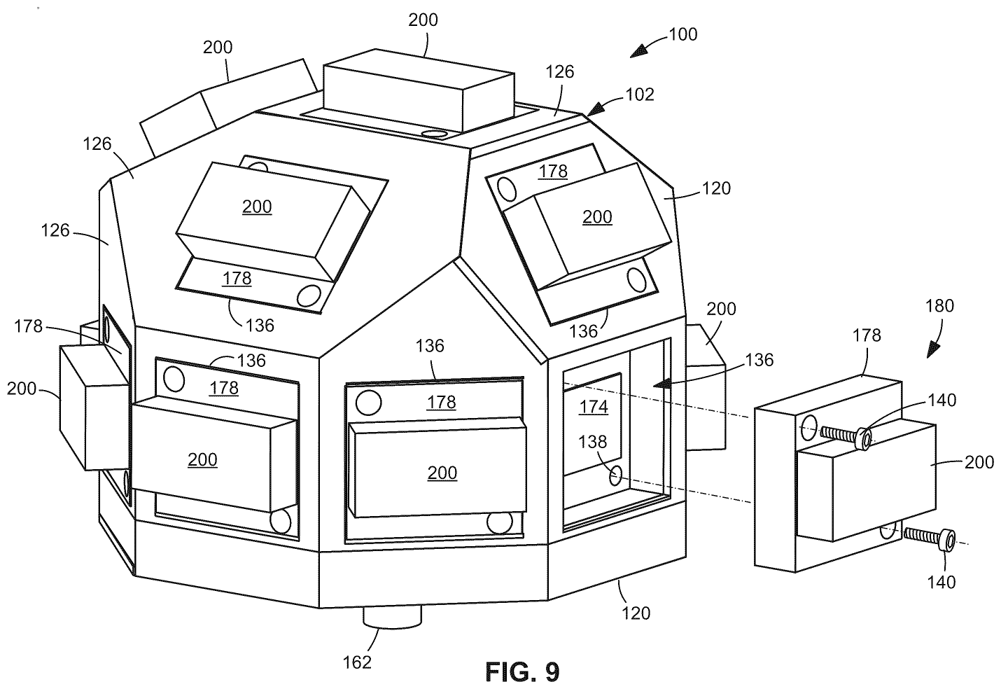

Referring to FIGS. 9 and 12, shown are examples of the grounding plates 174 and the sensor mounting plates 178. As mentioned above, the grounding plates 174 are electrically coupled to the grounding pin 162 via the grounding wires 182. Each grounding plate 174 is permanently attached or integrated into a pocket 136 of the sensor support frame 102 at one of the faces 126. Although the sensor support frame 102 is generally electrically non-conductive, the grounding plates 174 are formed of electrically conductive material such as metallic material (e.g., carbon steel). Each sensor mounting plate 178 is also formed of electrically conductive material and is configured to receive an impact sensor 200 to thereby form a sensor-plate assembly 180.

As shown in FIGS. 9-10 and 12, the pocket 136 at each face 126 is configured to receive a sensor mounting plate 178 of a sensor-plate assembly 180. Each sensor mounting plate 178 is removably attached to the pocket 136 via screws 140 that are extended through holes in the sensor mounting plate 178 and which threadably engage threaded holes or inserts 138 located in opposite corners at the bottom of each pocket 136. When a sensor-plate assembly 180 is installed in a pocket 136, the underside of the sensor mounting plate 178 is placed in physical contact with the outer side of the grounding plate 174, which automatically grounds the sensor mounting plate 178 to the grounding plate 174, thereby grounding the impact sensor 200 to the grounding pin 162.

Advantageously, the screws 140 for securing the sensor mounting plate 178 to the pocket 136 allow for quick and easy mounting and removal of the sensor-plate assemblies 180 from the verification tool 100. As a result, impact sensors 200 can be easily installed at any one of the faces 126 without compromising the grounding integrity of the impact sensors 200. Furthermore, the simple manner in which the sensor-plate assemblies 180 are installed and removed from the pockets 136 minimizes or eliminates the need for training to use the verification tool 100.

As described below, sensor-plate assemblies 180 can be installed on selected faces 126 in accordance with the location and/or orientation of the nozzles 310 of a shot peening machine 300. Pocket fillers (not shown) can be installed in pockets 136 where impact sensors 200 are not required. Such pocket fillers can be secured to the pockets 136 using screws 140 engaging the threaded inserts 138 on opposite corners of the pockets 136 similar to the mounting configuration of the sensor-plate assemblies 180. The pocket fillers can have the same dimensions (length, width, and height) as the sensor mounting plates 178, and can be formed of thermoplastic elastomer material such as thermoplastic polyurethane (TPU) to protect the pocket 136, the threaded inserts 138, and the grounding plate 174 from damage from high-velocity peening media 314.

Each pocket 136 is shaped and sized to closely conform to the shape and size of a sensor mounting plate 178. The close conformal fit minimizes gaps between the sides of the sensor mounting plate 178 and the sides of the pocket 136. By minimizing gaps between the sensor mounting plate 178 and the pocket 136, high-velocity peening media 314 (e.g., shot) is prevented from wedging between such gaps, which would otherwise damage the underlying primary structure 104. In the figures, the pockets 136 each have a rectangular shape. However, the pockets 136 can be non-rectangular or any other shape that is complementary to the shape of the sensor mounting plates 178. The pocket depth is complementary to the thickness of the sensor mounting plate 178 such that when a sensor-plate assembly 180 is installed in a pocket 136, the outer surface of the sensor mounting plate 178 is generally flush with the exterior surface of the face 126 (e.g., the protective outer layer 150) such that only the impact sensor 200 protrudes above the plane of the face 126.

As an alternative to grounding plates 174 and/or grounding wires 182, the grounding mechanism 160 can comprise a conductive membrane or a conductive lining (not shown) in the primary structure 104. For example, a layer of metallic mesh (not shown) can be integrated into the primary structure 104 in a manner such that the metallic mesh is in contact with the grounding pin 162 in the base portion 120 and with each grounding plate 174 in each pocket 136. When a sensor-plate assembly 180 is installed in a pocket 136, the underside of the sensor mounting plate 178 physically contacts the exposed surface of the grounding plate 174, thereby grounding the impact sensor 200 to the grounding pin 162 via the metallic mesh.

For examples of the verification tool 100 in which grounding of the impact sensors 200 is not required, the grounding plates 174, grounding wires 182, grounding pin 162, and pin housing 168 can be omitted. However, the sensor mounting plates 178 are retained as they function as adapters allowing for quick mounting of the impact sensors 200 to the pockets 136 using the externally accessible screws 140 shown in FIG. 9.

Referring to FIGS. 15-17 and 21, shown is an example of an impact sensor 200 and a sensor mounting plate 178 which, when assembled, form a sensor-plate assembly 180 (FIG. 15). In some examples, the impact sensor 200 has the same dimensions as a standard strip holder 404 (FIG. 21), also referred to as a J442 strip holder 404 as conventionally used for mounting a standardized Almen strip 402 (FIG. 21) as mentioned above. The dimensions of the J442 strip holder 404 are published by SAE International (i.e., Society of Automotive Engineers International) under the SAE J442 Standard, which lists the strip holder 404 dimensions as follows: length 76.4 mm, width 38 mm, and height 19 mm.

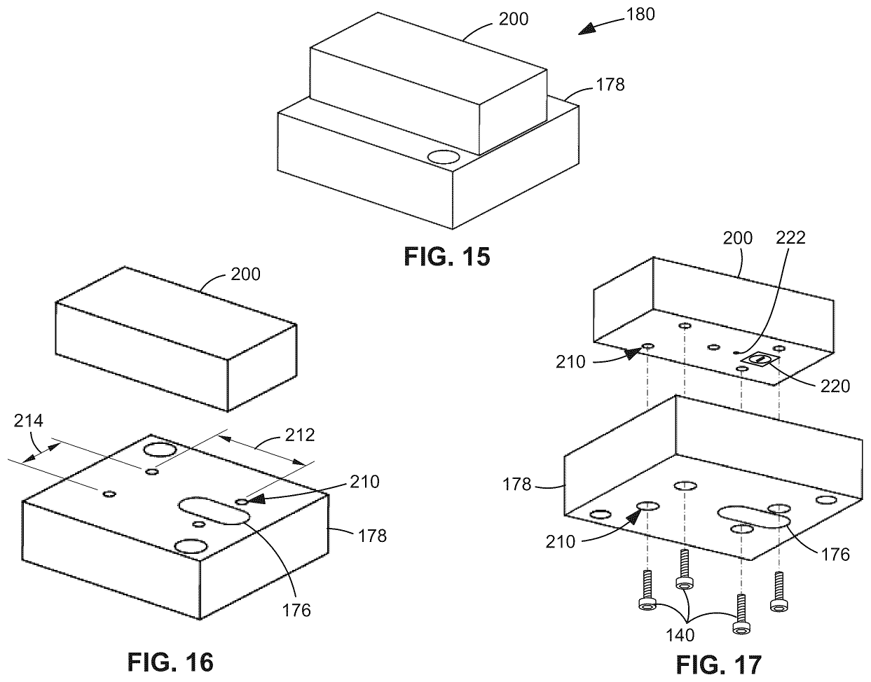

As shown in FIG. 17, the underside of the impact sensor 200 has a hole pattern 210 containing threaded holes arranged in a pattern width 214 of 24 mm and a pattern length 212 of 40 mm, which is the same hole pattern 210 specified for the J442 strip holder 404 in the SAE J442 Standard. As shown in FIG. 16, the sensor mounting plate 178 has a hole pattern 210 (e.g., counterbored holes) that matches the hole pattern 210 of the threaded holes in the impact sensor 200. The impact sensor 200 is coupled to the sensor mounting plate 178 using screws 140 inserted into the sensor mounting plate 178 holes from a backside of the sensor mounting plate 178. The screws 140 extend upwardly through the sensor mounting plate 178 and engage with the threaded holes in the impact sensor 200.

Referring still to FIGS. 16-17, each sensor mounting plate 178 has a through-hole 176, which is shown as a slot in the example. The through-hole 176 is sized and positioned to provide access to the impact sensor controls on the underside of the impact sensor 200 and which include impact sensor control such as an on/off switch 220, a reset button 222, and/or a status light (not shown). Advantageously, the through-hole 176 allows the impact sensor 200 to be activated/deactivated and/or reset in preparation for the next peening operation, and avoids the need to remove the screws 140 and separate each impact sensor 200 from its sensor mounting plate 178 after each peening operation to gain access to the impact sensor controls.

Referring to FIG. 18, shown is a side view of an example of an impact sensor 200 mounted to a sensor mounting plate 178, which is installed in a pocket 136 of the verification tool 100. FIG. 18 shows the impact sensor 200 subjected to peening media 314 discharged from a nozzle 310 of a shot peening machine 300. In this example, the impact sensor 200 is referred to an E-Strip™ and is commercially available from Shockform Aeronautics, Inc., of Quebec, Canada. The impact sensor 200 of FIG. 18 has a casing 202 which contains a battery 208, a transducer 204, and a transmission unit 206. The transducer 204 is located just below the upper surface and extends along the length of the casing 202. The transducer 204 is powered by the battery 208 and measures the energy of the peening media 314 impacting the upper surface of the casing 202.

In determining the energy of a stream 312 of peening media 314, the impact sensor 200 measures and records the total quantity of impacts and the impact force of each media particle. Each impact has a different impact force due to slight differences in the size, hardness, and/or velocity of individual media particles 316 in the stream 312. An algorithm averages the impact force of the media particles 316 when calculating the energy of the stream 312. The transducer 204 generates an electrical signal (e.g., an output voltage) representing the energy of the stream 312, and the transmission unit 206 converts the electrical signal to a digital signal and wirelessly transmits the digital signal to a computing device 216. The computing device 216 computes the peening intensity of the peening media 314 based on the energy measured by the transducer 204, and displays the value of the peening intensity on a display screen 218.

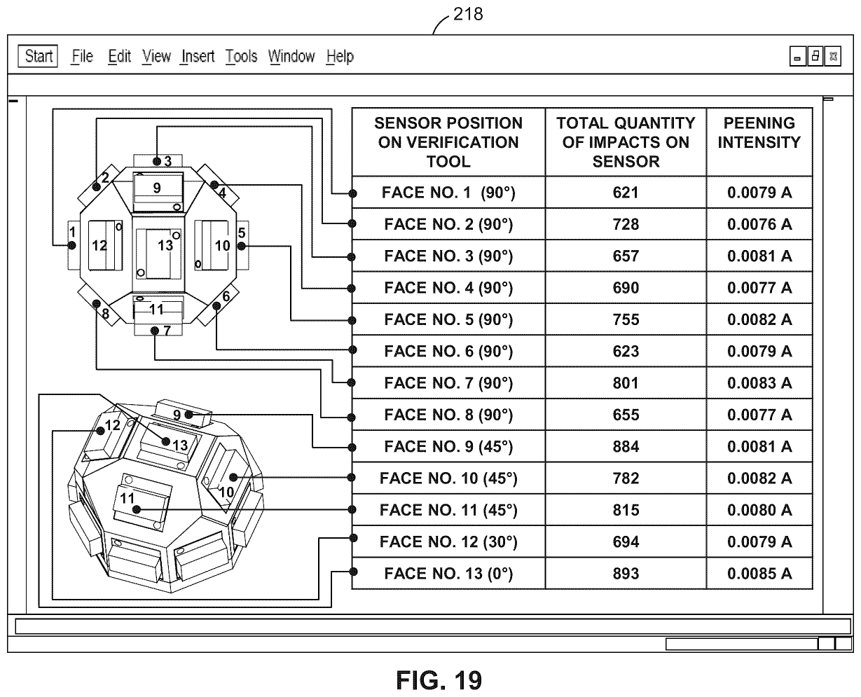

FIG. 19 shows an example of a display screen 218 of a computing device 216 listing the respective values of the peening intensity of multiple impact sensors 200 respectively mounted on multiple faces 126 of a verification tool 100. The sensor position (i.e., the face) of the impact sensor 200 on the verification tool 100 is also listed along with the total quantity of impacts of media particles 316 on the impact sensor 200. In some examples, when the transmission unit 206 of each impact sensor 200 transmits a digital signal representing the representing the recorded energy of a stream 312 of peening media 314, the transmission unit 206 encodes the digital signal with a serial number identifying the impact sensor 200. The computing device 216 can use the serial number to determine the sensor position (e.g., Face No. 1, 2, 3, etc.) of the impact sensor 200 on the verification tool 100 via a lookup table.

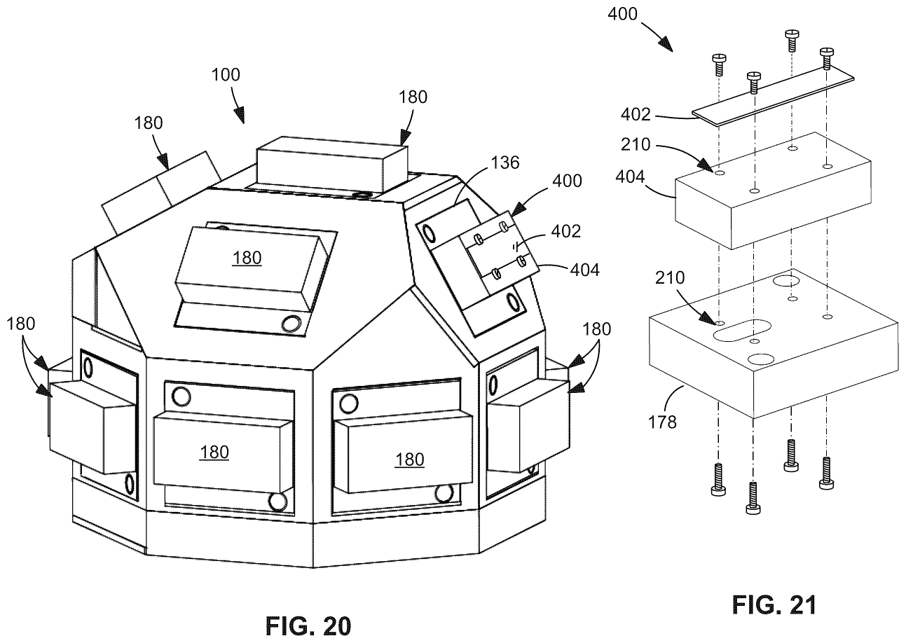

Referring to FIGS. 20-21, shown in FIG. 20 is an example of the verification tool 100 having a strip-plate assembly 400 mounted to one of the pockets 136 of the verification tool 100. Sensor-plate assemblies 180 are mounted to the remaining pockets 136 of the verification tool 100. FIG. 21 is an exploded view of the strip-plate assembly 400, which is comprised of an Almen strip 402 secured to a J442 strip holder 404 using four fasteners (e.g., screws 140) inserted into holes from a top side of the J442 strip holder 404. The strip-plate assembly 400 also includes the sensor mounting plate 178 which is secured to the J442 strip holder 404 using four fasteners (e.g., screws 140) inserted from an underside of the sensor mounting plate 178 similar to the arrangement in FIG. 17 for securing an impact sensor 200 to a sensor mounting plate 178. As mentioned above, the hole pattern 210 in the sensor mounting plate 178 matches the hole pattern 210 in the J442 strip holder 404, thereby providing a convenient means for securing the strip-plate assembly 400 via four fasteners. Mounting an Almen strip 402 on one of the faces 126 provides a means for calibrating the impact sensors 200 at the remaining faces 126 during the verification of a shot peening machine 300 using the verification tool 100, as described below.

Referring to FIGS. 22-23, shown in FIG. 22 is an example of an Almen strip 402 placed on a dial gauge 406 for measuring the arc height 408 of the Almen strip 402. The Almen strip 402 has an arc shape as a result of peening on one side only while supported on the verification tool 100 as shown in FIG. 20. FIG. 23 shows the arc height 408 of the Almen strip 402 as measured by the dial gauge 406 of FIG. 22. The arc height 408 is correlated to the peening intensity at the location (i.e., the face 126) on the verification tool 100 where the Almen strip 402 is mounted. The peening intensity of the Almen strip 402 is used to calibrate the impact sensors 200 on the remaining faces 126 of the verification tool 100. As an alternative to verifying peening intensity using impact sensors 200, the verification tool 100 can be used to verify peening intensity in the conventional manner described below by mounting strip-plate assemblies 400 to one or more faces 126 of the verification tool 100, and omitting sensor-plate assemblies 180 from the verification tool 100.

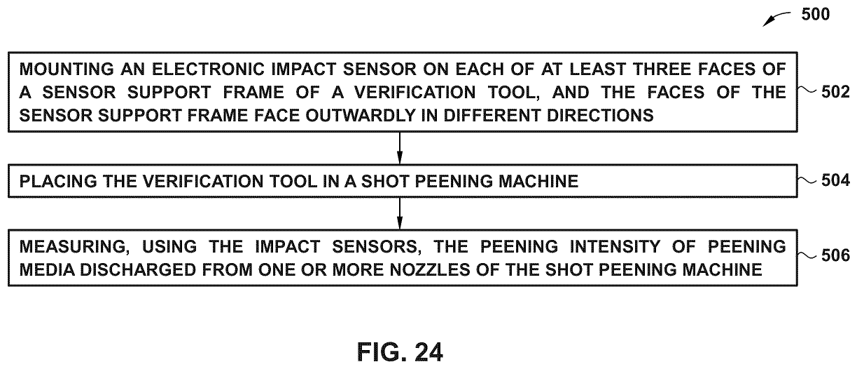

Referring to FIG. 24, shown is a flowchart of a method 500 of determining the peening intensity of a shot peening machine 300. Step 502 of the method 500 includes mounting an electronic impact sensor 200 on each of at least three faces 126 of a sensor support frame 102 of a verification tool 100. As mentioned above, the faces 126 of the verification tool 100 face outwardly in different directions. In the example, step 502 comprises mounting an impact sensor 200 on the faces 126 of the sensor support frame 102 having a primary structure 104 formed of a thermoplastic polymer material. For example, as described above, the primary structure 104 can be formed of acrylonitrile butadiene styrene (ABS) or any other preferably lightweight thermoplastic polymer that provides structural rigidity to the verification tool 100. In addition, step 502 comprises protecting the primary structure 104 from the peening media 314 via a protective outer layer 150 covering the primary structure 104 as shown in FIGS. 11-12. As described above, the protective outer layer 150 covers the exterior surfaces of the primary structure 104, and is preferably formed of a thermoplastic elastomer material such as thermoplastic polyurethane (TPU) for absorbing the energy of the peening media 314 and protecting the underlying primary structure 104.

In one example, step 502 of mounting the impact sensors 200 on the verification tool 100 comprises mounting an impact sensor 200 at least on each of three faces 126 respectively oriented at 30, 45, and 90 degrees. As described above, the orientation of each face 126 is measured relative to the base plane 124 of the verification tool 100 when the face 126 is viewed respectively from a side view perspective. FIGS. 5-9 and 12 illustrate a verification tool 100 having 13 faces 126, including eight 90-degree faces 128, three 45-degree faces 130, and one 30-degree face 132. The verification tool 100 also has one 0-degree face 134 which is located on top of the verification tool 100 and which is parallel to the base plane 124. In this example, the verification tool 100 has an impact sensor 200 mounted at each of the 13 faces 126.

However, it is not necessary to mount an impact sensor 200 on every face 126. The selection of which faces 126 to mount an impact sensor 200 can be based on the number of nozzles 310 of a shot peening machine 300, as the peening intensity can vary from nozzle 310 to nozzle 310. Alternatively or additionally, the selection of faces 126 can also be based on the number of locations where verification of the peening intensity is necessary. Faces 126 that are selected to receive an impact sensor 200 can be those that represent areas on a workpiece 318 (e.g., a production part) where peening has been prescribed. In some examples, it is only necessary to mount an impact sensor 200 on 45-degree faces 126 and 90-degree faces 128 in order to verify the peening intensity at locations between 45 and 90 degrees.

In another example, if a shot peening machine 300 has four nozzles 310 pointing in four different directions, then four faces 126 representing the four nozzle directions can be selected for mounting impact sensors 200. Additional faces 126 can be selected to represent the most common surface angles for peening a workpiece 318, and which typically fall between 45 and 90 degrees. As a result, only six impact sensors 200 are required for mounting on the verification tool 100 in this example. Pocket fillers (not shown) formed of thermoplastic elastomer material (e.g., TPU) can be installed in pockets 136 where impact sensors 200 are not required. As mentioned above, pocket fillers can be secured to the pockets 136 using screws 140 engaging the threaded inserts 138 located on opposite corners of the pockets 136.

The process of mounting impact sensors 200 to the verification tool 100 includes mechanically coupling each impact sensor 200 to a dedicated sensor mounting plate 178 to form a sensor-plate assembly 180, and then mounting the sensor-plate assembly 180 in a pocket 136 in the verification tool 100. For example, FIGS. 15-17 show an impact sensor 200 coupled to a sensor mounting plate 178 using screws 140 inserted in the sensor mounting plate 178 holes from a backside of the sensor mounting plate 178. The screws 140 extend upwardly through the sensor mounting plate 178 and engage with the threaded holes formed in the impact sensor 200. For impact sensors 200 that require grounding to the shot peening machine 300, the act of mechanically coupling each impact sensor 200 to a sensor mounting plate 178 serves to electrically couple the impact sensor 200 to the sensor mounting plate 178. Each impact sensor 200 can be activated (i.e., turned on) via a through-hole 176 in the sensor mounting plate 178 which provides access to an on-off switch. Alternatively, each impact sensor 200 can be activated prior to assembly with a sensor mounting plate 178.

Once the impact sensors 200 are activated, each sensor-plate assembly 180 can be installed in a pocket 136 of the verification tool 100. As mentioned above, each pocket 136 is shaped and sized complementary to each sensor mounting plate 178. FIG. 9 illustrates the mounting of a sensor mounting plate 178 to a pocket 136 using screws 140 that are extended through holes in the sensor mounting plate 178. The threads of the screws 140 engage the threaded holes or inserts 138 installed in opposite corners at the bottom of the pocket 136. When a sensor-plate assembly 180 is installed in a pocket 136, the underside of the sensor mounting plate 178 is placed in physical contact with the outer side of a grounding plate 174 of the primary structure 104. As a result, the mounting of a sensor-plate assembly 180 in a pocket 136 automatically grounds the sensor mounting plate 178 to the grounding plate 174.

Referring to FIGS. 20-21, in some examples of the method 500 such as during the initial use of the impact sensors 200, a strip-plate assembly 400 can be mounted to one of the faces 126 instead of a sensor-plate assembly 180, to provide a means for calibrating the sensor-plate assemblies 180 on the remaining faces 126 of the verification tool 100. In this scenario, the method includes forming a strip-plate assembly 400 by mounting an Almen strip 402 on a J442 strip holder 404 using four fasteners (e.g., screws 140), and mounting the J442 strip holder 404 on a sensor mounting plate 178 using four fasteners (e.g., screws 140) inserted from the underside of the sensor mounting plate 178 as shown in FIG. 21. The strip-plate assembly 400 is installed in one of the pockets 136 using the same two fasteners used for installing a sensor-plate assembly 180 as shown in FIG. 9.

Step 504 of the method 500 includes placing the verification tool 100 in a shot peening machine 300 similar to the example shown in FIG. 5. For impact sensors 200 that require grounding, step 504 includes electrically coupling each impact sensor 200 to the shot peening machine 300 via a grounding mechanism 160 mounted to the sensor support frame 102. For example, coupling each impact sensor 200 to the shot peening machine 300 comprises placing a grounding pin 162 in contact with a table 306 of the shot peening machine 300 when the verification tool 100 is installed in the shot peening machine 300. As shown in FIG. 12 and described above, the grounding pin 162 is mounted to the base portion 120 of the sensor support frame 102. Each impact sensor 200 is electrically coupled to the grounding pin 162 via a grounding wire 182 as shown in the examples of FIGS. 13-14.

To ensure that the impact sensors 200 are continuously grounded during a peening operation, the method 500 includes biasing the grounding pin 162 downwardly from the base portion 120 into contact with the table 306 when the verification tool 100 is installed in the shot peening machine 300. As shown in FIG. 12, a compression spring 164 urges the grounding pin 162 downwardly through an opening in the elastomeric mat 308 and into contact with the metallic table 306 of the shot peening machine 300. Once the verification tool 100 is secured to the table 306, the shot peening machine 300 is activated to start peening the verification tool 100. The method 500 includes recording the peening parameters of the shot peening machine 300 such as air pressure (e.g., psi) at each nozzle 310 and volumetric flow rate (e.g., pounds per minute) of the peening media 314 at each nozzle 310.

Step 506 of the method 500 includes measuring, using the impact sensors 200, the peening intensity of peening media 314 discharged from one or more nozzles 310 of the shot peening machine 300. As shown in FIG. 18, the peening media 314 impacts the upper surface of the casing 202 of the impact sensor 200. Step 506 includes measuring the energy of the peening media 314 using a transducer 204 located just below the upper surface of the casing 202. As described above, the transducer 204 records the total quantity of impacts and the impact force of each medial particle impacting the upper surface, and generates an electrical signal representative of the energy of the peening media 314.

At the conclusion of a predetermined period of time (e.g., 5 minutes), the shot peening machine 300 is stopped, the verification tool 100 is removed from the shot peening machine 300, and peening intensity data is downloaded from the impact sensors 200. In this regard, step 506 includes using a transmission unit 206 in each impact sensor 200 to convert the electrical signal to a digital signal, and transmitting the digital signal to a computing device 216 which can be located proximate an exterior of the shot peening machine 300. Step 506 includes computing, using the computing device 216, the peening intensity of the peening media 314 based on the energy measured by the transducer 204 of each impact sensor 200. For example, FIG. 19 shows a display screen 218 of a computing device 216 listing the values of the peening intensity for each impact sensor 200 mounted on the verification tool 100, along with the total quantity of impacts of media particles 316 on each impact sensor 200.

Referring to FIGS. 20-23, for examples in which a strip-plate assembly 400 is mounted to one of the faces 126 of the verification tool 100 as shown in FIG. 20, the method includes removing the Almen strip 402 from the sensor mounting plate 178 at the conclusion of the predetermined period of time, and placing the Almen strip 402 on a dial gauge 406 as shown in FIG. 22. The method 500 additionally includes using the dial gauge 406 to measure the arc height 408 (FIG. 23) of the Almen strip 402, and correlating the arc height 408 to the peening intensity of the peening media 314 at the location of the Almen strip 402 in the shot peening machine 300. The peening intensity of the impact sensors 200 on the remaining faces 126 of the verification tool 100 can be calibrated based on the peening intensity of the Almen strip 402. In some examples, the method 500 can include determining the peening intensity of a shot peening machine 300 in the conventional manner as described above by mounting only strip-plate assemblies 400 to one or more faces 126 of the verification tool 100, and subjecting the Almen strips 402 to peening media 314 in the shot peening machine 300. Each peened Almen strip 402 is then placed on a dial gauge 406 (i.e., an Almen gauge) for measuring the arc height 408, which is then correlated to peening intensity.

Many modifications and other versions and examples of the disclosure will come to mind to one skilled in the art to which this disclosure pertains having the benefit of the teachings presented in the foregoing descriptions and the associated drawings. The versions and examples described herein are meant to be illustrative and are not intended to be limiting or exhaustive. Although specific terms are employed herein, they are used in a generic and descriptive sense only and not for purposes of limitation. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

What is claimed is:

1. A verification tool for determining a peening intensity of a shot peening machine, comprising:
a sensor support frame configured to be mounted within a shot peening machine, the sensor support frame has at least three faces facing outwardly in different directions, and each face is configured to receive an electronic impact sensor configured to measure the peening intensity of peening media discharged from one or more nozzles of the shot peening machine.

2. The verification tool of claim 1, further comprising:
a grounding mechanism includable with the sensor support frame and configured to electrically ground the impact sensors to the shot peening machine.

3. The verification tool of claim 2, wherein:
the sensor support frame has a base portion;
the grounding mechanism comprises:
a grounding pin mountable to the base portion and configured to contact a table of the shot peening machine when the verification tool is installed in the shot peening machine; and
a grounding wire extendable from each impact sensor to the grounding pin.

4. The verification tool of claim 2, further comprising:
at least one grounding plate configured to be affixed to one of the faces and electrically couplable to the grounding mechanism; and
at least one sensor mounting plate mechanically and electrically couplable to one of the impact sensors to form a sensor-plate assembly, and the sensor mounting plate is configured to be removably attached to one of the faces in a manner such that the sensor mounting plate is electrically coupled to the grounding plate.

5. The verification tool of claim 4, wherein:
each face has a pocket sized and configured to receive one of the sensor mounting plates of one of the sensor-plate assemblies.

6. The verification tool of claim 1, wherein:
each impact sensor has a transducer and a transmission unit;
the transducer is configured to measure energy of the peening media and generate an electrical signal representative of the peening intensity; and
the transmission unit is configured to transmit a digital signal representative of the electrical signal to a computing device for computing the peening intensity of the peening media based on the energy measured by the transducer.

7. The verification tool of claim 1, wherein:
the sensor support frame has a base portion defining a base plane; and
the at least three faces of the sensor support frame are respectively oriented at 30, 45, and 90 degrees relative to a normal to the base plane when the faces are respectively viewed from a side view perspective.

8. The verification tool of claim 1, wherein:
the sensor support frame has a primary structure containing the at least three faces and formed of a thermoplastic polymer material.

9. The verification tool of claim 1, wherein:
the sensor support frame comprises a protective outer layer formed of a thermoplastic elastomer material and configured to cover exterior surfaces of the primary structure.

10. A verification tool for determining a peening intensity of a shot peening machine, comprising:
a sensor support frame configured to be mounted within the shot peening machine, the sensor support frame has at least three faces facing outwardly in different directions; and
an electronic impact sensor mountable to each of the faces, each impact sensor is configured to measure the peening intensity of peening media discharged from one or more nozzles of the shot peening machine.

11. A method of determining a peening intensity of a shot peening machine, comprising:
mounting an electronic impact sensor on each of at least three faces of a sensor support frame of a verification tool, and the faces of the sensor support frame face outwardly in different directions;
placing the verification tool in a shot peening machine; and
measuring, using the impact sensors, the peening intensity of peening media discharged from one or more nozzles of the shot peening machine.

12. The method of claim 11, further comprising:
electrically coupling each impact sensor to the shot peening machine via a grounding mechanism mounted to the sensor support frame.

13. The method of claim 12, wherein electrically coupling each impact sensor comprises:
placing a grounding pin in contact with a table of the shot peening machine when the verification tool is installed in the shot peening machine, the grounding pin is mounted to a base portion of the sensor support frame, and each impact sensor is electrically coupled to the grounding pin via a grounding wire.

14. The method of claim 13, wherein:
biasing the grounding pin from the base portion into contact with the table when the verification tool is installed in the shot peening machine.

15. The method of claim 12, further comprising:
mechanically and electrically coupling each impact sensor to a dedicated sensor mounting plate to form a sensor-plate assembly; and
releasably attaching the sensor mounting plate of each sensor-plate assembly to a grounding plate that is affixed to one of the faces and electrically coupled to the grounding mechanism.

16. The method of claim 15, wherein releasably attaching the sensor mounting plate of each sensor-plate assembly to a grounding plate comprises:
installing the sensor mounting plate of each sensor-plate assembly into a pocket formed in one of the faces, and each pocket is shaped and sized complementary to each sensor mounting plate.

17. The method of claim 11, wherein measuring the peening intensity of the peening media comprises:
measuring energy of the peening media using a transducer of each impact sensor, and generating an electrical signal representative of the peening intensity; and
transmitting, using a transmission unit of each impact sensor, a digital signal representative of the electrical signal to a computing device for computing the peening intensity of the peening media based on the energy measured by the transducer.

18. The method of claim 11, wherein mounting an impact sensor on each of the at least three faces comprises:
mounting an impact sensor on each of three faces respectively oriented at 30, 45, and 90 degrees relative to a normal to a base plane of the support frame when the faces are respectively viewed from a side view perspective.

19. The method of claim 11, wherein mounting an impact sensor on each of at least three faces comprises:
mounting an impact sensor on each of the faces of the sensor support frame having a primary structure formed of a thermoplastic polymer material.

20. The method of claim 11, further comprising:
protecting the primary structure from the peening media via a protective outer layer covering the primary structure and formed of a thermoplastic elastomer material.
